(19) United States
(12) Patent Application Publication
(10) Pub. No.: US 2026/0012896 A1
(43) Pub. Date: Jan. 8, 2026

(54) SYSTEM AND METHOD FOR AUTOMATIC TOPOGRAPHIC INTERFERENCE DETECTION AND MITIGATION BASED ON NETWORK DATA

(71) Applicant: JIO PLATFORMS LIMITED, Ahmedabad (IN)

(72) Inventors: Polsoni Chaitanya REDDY, Tellapur, Hyderabad (IN); Vivek PATEL, Indore (IN); Mukesh KUMAR, Indore (IN); Makarand DERE, Panvel (IN); Aayush BHATNAGAR, Navi Mumbai (IN); Pradeep Kumar BHATNAGAR, Navi Mumbai (IN); Haresh AMBALIYA, Jahangirpura, Surat (IN); Vikram SINGH, Navi Mumbai (IN)

(73) Assignee: JIO PLATFORMS LIMITED, Ahmedabad (IN)

(21) Appl. No.: 18/879,926

(22) PCT Filed: Sep. 30, 2023
(86) PCT No.: PCT/IB2023/059829

§ 371 Date: Dec. 30, 2024

(30) Foreign Application Priority Data
Sep. 30, 2022 (IN) 202221056430

(51) Int. Cl. H04W 52/24; H04W 52/22

(52) U.S. Cl. CPC H04W 52/243; H04W 52/223

(57) ABSTRACT

The present disclosure provides a system and a method for automatic topographic interference detection and mitigation based on network data. The system identifies aggressor/source cells from base stations based on various parameters. The system groups the source cells into a high, a medium, and a low state, and applies a radio frequency (RF) tilt and associated power attenuation on the frequency division duplex (FDD) and the time division duplex (TDD) cells of multiple regions for a predetermined period. The system predicts interferences associated with the source cells based on the parameters. Further, the system dynamically updates the RF tilt and the associated power attenuation for the predetermined period. The system determines a decrease in the automatic topographic interference and reverts the RF tilt and the associated power attenuation for the source cells.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for interference mitigation in a radio access network (RAN) that automatically resolves interference caused by macros/eNodeB and radio network elements which are geographically separated by predetermined distances. More particularly, the present disclosure relates to a system and a method for automatic topographic interference detection and mitigation based on network data.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Topographic radio wave bending is an ever changing dynamic based on atmospheric conditions in the regions where radio network elements are deployed. The process of interference data capture and an impact associated with the interference may be a never ending cycle. Current systems for interference detection requires and involve complex processes. Victim cells on which the interference is identified may be analyzed and corrective measures may be provided. However, this involves a manual job and may take days/weeks to process this data, but by then, the victim cells on which interference needed to be applied may or may not be facing interference.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method where a complete network interference detection and mitigation is achieved with zero human intervention.

It is an object of the present disclosure to provide a system and a method where interference data from different sources in extracted in different formats across the network and captured in real time.

It is an object of the present disclosure to provide a system and a method where data from various sources is used to analyze and provide predictions regarding network elements being impacted as well as network elements in which regions are going to be impacted respectively.

It is an object of the present disclosure to provide a system and a method that provides predictions regarding a radio frequency (RF) tilt and a transmit power associated with antennas that is applied across the network in real time.

It is an object of the present disclosure to provide an automated system to mitigate interference in a continuous fashion along with multiple options to optimize the system with minor configuration tweaks.

It is an object of the present disclosure to provide a system and a method that determines topographic interference mitigation across local and inter-state geographies and provides a self-learning adaptive system to resolve the interference caused by different macros/base stations across different geographic locations.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for automatic interference detection. The system includes a processor, and a memory operatively coupled to the processor, where the memory stores instructions to be executed by the processor. The processor receives one or more parameters from one or more base stations. The processor identifies one or more interference source cells based on the one or more parameters. The processor categorizes the one or more interference source cells based on one or more regions. The processor determines a state of frequency division duplex (FDD) cells among the categorized one or more interference source cells. The processor enables a radio frequency (RF) tilt and an associated power attenuation for time division duplex (TDD) cells associated with the FDD cells of the one or more regions for a predetermined period based on the determined state. The processor dynamically updates the RF tilt and the associated power attenuation for the TDD cells for the predetermined period.

In an embodiment, the one or more parameters may include at least one of a time duration, an interference level, a geographic distance, a confidence level, and a cell count.

In an embodiment, the processor may predict interferences associated with the one or more interference source cells based on the one or more parameters.

In an embodiment, the processor may enable the RF tilt and the associated power attenuation by applying an upper side lobe suppression (USLS) and aggressive tilt on the TDD cells based on the state of the FDD cells being one of a high state, a medium state, and a low state.

In an embodiment, the processor may apply a non-USLS and relaxed tilt on the TDD cells based on the state of the FDD cells being a healthy state.

In an embodiment, the categorization of the one or more interference source cells may be based on at least one of a district, a state, a country, Element Management System (EMS) across the one or more regions, and individual EMS.

In an embodiment, the processor may determine a decrease in interference of the one or more interference source cells in response to enabling of the RF tilt and the associated power attenuation, and revert the RF tilt and the associated power attenuation based on the determination of the decrease in the interference.

In an embodiment, the processor may determine the RF tilt based on a main lobe power below a horizon, a main lobe power above the horizon, and a total power associated with one or more upper side lobes from the one or more interference source cells.

In an embodiment, the processor may generate a report comprising information corresponding to the one or more interference source cells.

In an aspect, the present disclosure relates to a method for automatic interference detection. The method includes receiving, by a processor associated with a system, one or more parameters from one or more base stations. The method includes identifying, by the processor, one or more interference source cells based on the one or more parameters. The method includes categorizing, by the processor, the one or more interference source cells based on one or more regions. The method includes determining, by the processor, a state of FDD cells among the categorized one or more interference source cells. The method includes enabling, by the processor, a RF tilt and an associated power attenuation for TDD cells associated with the FDD cells of the one or more regions for a predetermined period based on the determined state. The method includes dynamically updating, by the processor, the RF tilt and the associated power attenuation for the TDD cells for the predetermined period.

In an embodiment, the method may include determining, by the processor, a decrease in an interference of the one or more interference source cells in response to enabling of the RF tilt and the associated power attenuation, and reverting the RF tilt and the associated power attenuation based on determining the decrease in the interference.

In an embodiment, the method may include applying, by the processor a USLS and aggressive tilt on the TDD cells based on the state of the FDD cells being one of a high state, a medium state, and a low state.

In an embodiment, the method may include applying, by the processor, a non-USLS and relaxed tilt on the TDD cells based on the state of the FDD cells being a healthy state.

In an aspect, a non-transitory computer readable medium includes a processor with executable instructions that cause the processor to receive one or more parameters from one or more base stations. The processor identifies one or more interference source cells based on the one or more parameters. The processor categorizes the one or more interference source cells based on one or more regions. The processor determines a state of FDD cells among the categorized one or more interference source cells. The processor enables a RF tilt and an associated power attenuation for TDD cells associated with the FDD cells of the one or more regions for a predetermined period based on the determined state. The processor dynamically updates the RF tilt and the associated power attenuation for the TDD cells for the predetermined period.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example network architecture (100) for implementing a proposed system (108), in accordance with an embodiment of the present disclosure.

FIG. 2 illustrates an example block diagram (200) of a proposed system (108), in accordance with an embodiment of the present disclosure.

FIG. 3 illustrates an example diagram (300) of a topographic interference mitigation (TIM) system architecture, in accordance with an embodiment of the present disclosure.

FIGS. 4A-4C illustrate example flow diagrams (400A, 400B, 400C) of TIM processing, in accordance with embodiments of the present disclosure.

FIG. 5 illustrates an example computer system (500) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure provides a network interference detection and mitigation system with zero human intervention. This may be achieved by extracting input data from different sources in different formats, including interference data captured in real time across the network. The system may predict a severity of impact on different regions where the network elements exist. Data from these data sources may be used to analyze and provide a prediction regarding network elements being impacted as well as network elements which may be impacted respectively in various regions. Based on predictions, changes involving tilt and transmit power may be triggered in dynamically evaluated steps and applied across the network in real time.

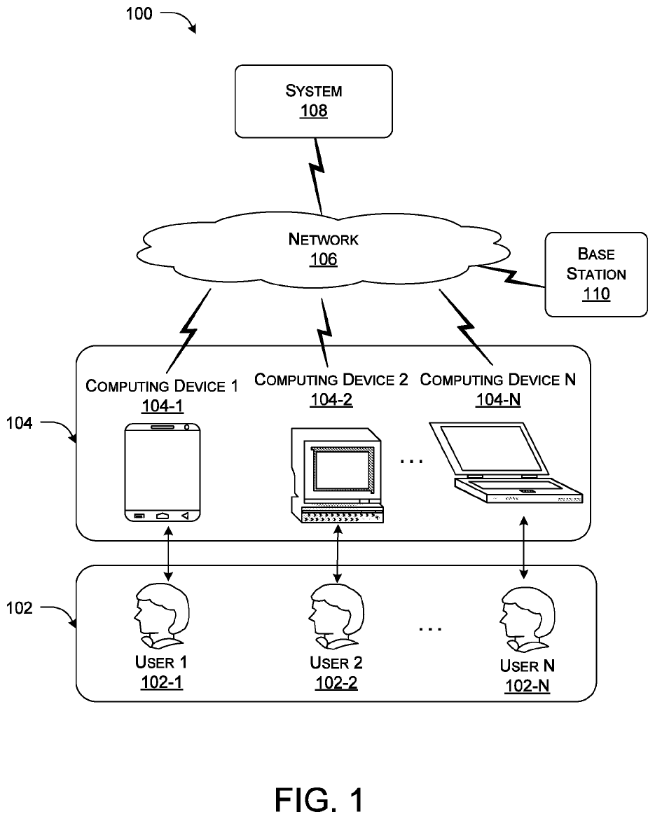

Various embodiments of the present disclosure will be explained in detail with reference to FIGS. 1-5.

FIG. 1 illustrates an example network architecture (100) for implementing a proposed system (108), in accordance with an embodiment of the present disclosure.

As illustrated in FIG. 1, the network architecture (100) may include a system (108). The system (108) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). The system (108) may also be connected to one or more base stations (110) via the network (106). In an embodiment, the system (108) may refer to a topographic interference mitigation (TIM) system that processes various inputs from the one or more base stations (110). Although one base station (110) is depicted, it may be appreciated that any number of base stations (110) may be present within the scope of the present disclosure.

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (108) may receive one or more parameters from one or more base stations. The one or more parameters may include, but not limited to, a time duration, an interference level, a geographic distance, a confidence level, and a cell count.

In an exemplary embodiment, the time duration may include a session of thirty minutes each and the interference level may be greater than-110 dBm. The geographical distance may include distances more than 200 kilometres and the confidence count may greater than or equal to 2. Further, the cell count may be greater than 5.

In an embodiment, the system (108) may identify one or more interference source cells based on the one or more parameters. The system (108) may categorize the one or more interference source cells based on one or more regions. The categorization may be further based on, but not limited to, a district, a state, a country, Element Management System (EMS) across the one or more regions, and individual EMS.

In an embodiment, the system (108) may determine a state of frequency division duplex (FDD) cells among the categorized one or more interference source cells. The state may include a high state, a medium state, a low state, and a healthy state.

In an embodiment, downlink and uplink transmissions may be organized into a frequency division duplex (FDD) mode and a time division duplex (TDD) mode. The FDD mode may utilize a paired spectrum where the frequency domain is used to separate the uplink (UL) and the downlink (DL) transmissions. The TDD mode may utilize a common spectrum and depend on time multiplexing to separate the UL and the DL transmissions.

In an embodiment, the system (108) may enable a radio frequency (RF) tilt and an associated power attenuation for the TDD cells associated with the FDD cells of the one or more regions for a predetermined period based on the determined state. The system (108) may determine the RF tilt based on a main lobe power below a horizon, a main lobe power above the horizon, and a total power associated with one or more upper side lobes from the one or more interference source cells. Further, the system (108) may map the RF tilt and the associated power attenuation based on an upper side lobe suppression (USLS) logic associated with the one or more interference source cells.

In an embodiment, the system (108) may predict interferences associated with the one or more interference source cells based on the one or more parameters. The system (108) may dynamically update the RF tilt and the associated power attenuation for the predetermined period.

In an embodiment, the system (108) may determine a decrease in the interference based on the changes applied, i.e. RF tilt and associated power attenuation, and revert the RF tilt and the associated power attenuation based on the decrease in the interference.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

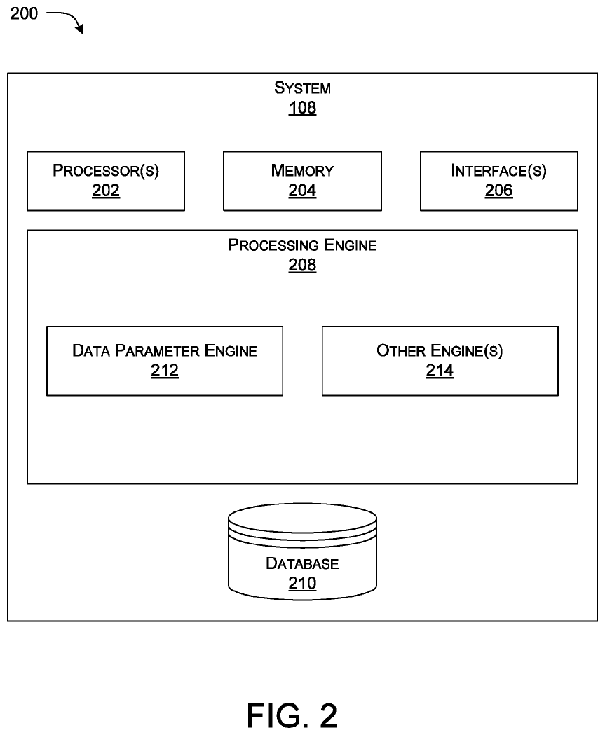

FIG. 2 illustrates an example block diagram (200) of a proposed system (108), in accordance with an embodiment of the present disclosure.

Referring to FIG. 2, the system (108) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (108). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (108) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (106). Examples of such components include, but are not limited to, processing engine(s) (208) and a database (210), where the processing engine(s) (208) may include, but not be limited to, a data ingestion engine (212) and other engine(s) (214). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (108) may comprise the machine-readable storage medium storing the instructions and the processing resource to execute the instructions, or the machine-readable storage medium may be separate but accessible to the system (108) and the processing resource. In other examples, the processing engine(s) (208) may be implemented by electronic circuitry.

In an embodiment, the processor (202) may receive one or more parameters via the data ingestion engine (212). The one or more parameters may be received from one or more base stations. The processor (202) may store the one or more parameters in the database (210). The one or more parameters may include, but not limited to, a time duration, an interference level, a geographic distance, a confidence level, and a cell count.

In an embodiment, the processor (202) may identify one or more interference source cells based on the one or more parameters. The processor (202) may categorize the one or more interference source cells based on one or more regions. The categorization may be based on, but not limited to, a district, a state, a country, the EMS across the one or more regions, and the individual EMS.

In an embodiment, the processor (202) may determine a state of FDD cells among the categorized one or more interference source cells. The categories may include, but not limited to, a high state, a medium state, a low state, and a high state.

In an embodiment, the processor (202) may enable a RF tilt and an associated power attenuation for the TDD cells associated with the FDD cells of the one or more regions for a predetermined period based on the determined state. The processor (202) may determine the RF tilt based on a main lobe power below a horizon, a main lobe power above the horizon, and a total power associated with one or more upper side lobes from the one or more interference source cells. Further, the processor (202) may map the RF tilt and the associated power attenuation based on an USLS logic associated with the one or more interference source cells. For example, the processor (202) may apply the USLS and aggressive tilt on the TDD cells based on the state of the FDD cells being one of: the high state, the medium state, and the low state. The processor (202) may apply non-USLS and relaxed tilt on the TDD cells based on the state of the FDD cells being the healthy state.

In an embodiment, the processor (202) may predict interferences associated with the one or more interference source cells based on the one or more parameters. The processor (202) may dynamically update the RF tilt and the associated power attenuation for the predetermined period.

In an embodiment, the processor (202) may determine a decrease in the interference via the one or more parameters and revert the RF tilt and the associated power attenuation.

In an embodiment, the system (108) may determine the tilt and power changes based on aggressor cell identification as shown below.

$$Aggressor Cell Identification = {TD}_{30 mins} ⋂ {I}_{GT = 110 Dbm} ⋂ {Dist}_{> 200 kms} ⋂ {Cofd}_{>= 2} ⋂ {VC}_{> 5 cells} , \qquad ( 1 )$$

where, TD may be a time duration, I may be an interference level, Dist may be a geographic distance, Cofd may be a confidence level, and VC may be a victim cell count. Work order may be created for the ‘Aggressor Cells Identified’ i.e., “WO_{ACI}” may be identified by (1) listed above. Further, future Cell Interference Prediction may be based on an ‘intersection’ of all the above configured co-efficients.
Regional selections=EMS_{regions}⊆CWR
where, CWR—Country Wide Regional servers
EMS_{regions}—Element management Systems catering to the specific regions
EMS_{regions} may be a subset of or equal to CWR

$$RF tilt changes may be mapped to each cell based on USLS logic = {RF}_{CellTilt} \qquad ( 2 )$$

$$RF tilt changes may be mapped to each cell based on non - USLS logic = {RF}_{CellTilt} \qquad ( 2.1 )$$

$$Power Attenuation = {PWR}_{Attenuation} \qquad ( 3 )$$

In an embodiment of execution 1, RF_{CellTilt} and PWR_{Attenuation} are applied on cells in WO_{ACI}

$$RF original tilt of each cell is stored = {RF}_{OriginalTilt} \qquad ( 4 )$$

$$Power Attenuation Original = {PWR}_{OriginalAttenuation} \qquad ( 5 )$$

$$Time Duration Revert Interval = {TD}_{RevertInternal} \qquad ( 6 )$$

After the Interference decreases, RF Tilt and Power Attenuation may be reverted, i.e.

$$Aggressor Cell Revert i . e . , {WO}_{ACR} = {TD}_{RevertInterval} ⋂ {I}_{GT - 110 Dbm} ⋂ {Dist}_{> 200 kms} ⋂ {Cofd}_{>= 2} ⋂ {VC}_{> 5 cells} \qquad ( 7 )$$

In an embodiment of execution 2, RF_{OriginalTilt} and PWR_{OriginalAttenuation} may be applied on the cells in WO_{ACR}

Apart from the decrease in interference, the RF tilt and power attenuation reverts may be based on 24-hours prior data that is reverted. In the previous day, if the interference decreases prior to the 5-hour interval where it may be planned for tilt revert, then the interference decrease time may be marked. i.e. if the interference decreased after 2 hours then TD_{RevertInterval} reversal time may be changed to 2 hours for that specific cell. This value may be used in the following day that is listed below.

$$Time Duration Revert Interval based on previous 24 hours data = {TD}_{24 HourRevert} \qquad ( 8 )$$

TD_{24HourRevert} may be 2 hours for that cell i.e., each cell's revert interval may vary based on previous day's data.

$$Aggressor Cell Revert based on 24 hour revert data i . e . , {WO}_{ACR24Hours} = {TD}_{24 HourRevert} ⋂ {I}_{GT - 110 Dbm} ⋂ {Dist}_{> 200 kms} ⋂ {Cofd}_{>= 2} ⋂ {VC}_{> 5 cells} \qquad ( 9 )$$

In an embodiment, of execution 3RF_{OriginalTilt} and PWR_{OriginalAttenuation} may be applied on cells identified in WO_{ACR24Hours Reverting the tilt changes applied in “Execution I” can be realized by}

$${\sum }_{i = 2}^{n} Execution$$

In the above:
i=2=>Execution 2
i=3=>Execution 3 which can be only in one interval or may be in multiple intervals going up to “i=n” intervals.

In case of each aggressor cell's other bands (e.g.: 1800, 850), the FDD cells status may be checked for the one or more conditions (a high state, a medium state, and a low state). If the other cells in the same node fall in any of these three types (the high state, the medium state, and the low state), then appropriate tilt and power changes may be applied. If the other cells in the same node do not fall in any of these three types (the high state, the medium state, and the low state), then the tilt and power changes may be varied based on a requirement. Similarly, for every cycle of revert time duration, appropriate tilt and power changes may be applied.

In an embodiment, Table 1 represents the one or more states/conditions of the FDD cells, as an example configuration.

TABLE 1

| | DL PRB | |
|---|---|---|
| | Utilization | DL Throughput |
| High state | >70% | <512 Kilobytes per |
| | | second (KBPS) |
| Medium state | >70% | >512 KBPS < 1024 |
| | | KBPS |
| Low state | >70% | >1024 KBPS < 2048 |
| | | KBPS |

Although FIG. 2 shows exemplary components of the system (108), in other embodiments, the system (108) may include fewer components, different components, differently arranged components, or additional functional components than depicted in FIG. 2. Additionally, or alternatively, one or more components of the system (108) may perform functions described as being performed by one or more other components of the system (106).

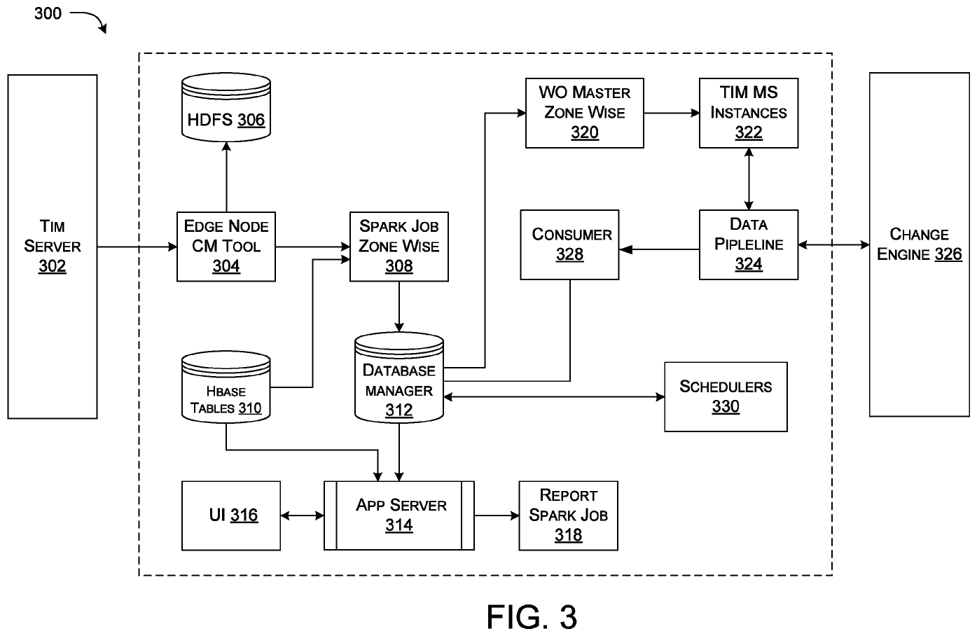

FIG. 3 illustrates an example diagram (300) of a topographic interference mitigation (TIM) system architecture, in accordance with an embodiment of the present disclosure.

In an embodiment, a TIM server (302) may extract aggressor victim cell pairs in a specified duration across one or more parameters. Further, the identified aggressors meeting differing criteria's may be grouped through across differing geographic regions or across multiple (EMS). The TIM server (302) may determine a behaviour of FDD cells (the high state, the medium state, the low state, and the healthy state). This may address whether an aggressive (USLS tilt based on power above horizon) or a relaxed E-tilt for the TDD cell may be implemented.

In an embodiment, the RF tilt may be applied to the aggressors based on the USLS or a non-USLS logic and further associated power attenuations may be applied. These modifications may be applied through different work orders processed by a change engine change engine (CE) (326). Further, the TIM server (302) may monitor a reported aggressor in subsequent data to identify a reduction in an actual interference based on an interference power and reduction in the number of victims for each aggressor.

In an embodiment, the TIM server (302) may receive processed data from the CE (326). Further, the TIM server (302) may apply specific business rules on the processed data to identify success and failure scenarios. In cases of failure scenarios, root cause analysis (RCA) data may be extracted from (MML) logs. These success and failure reports along with RCA may be created and shared with an operations and management (O&M) team.

In an embodiment, the CE (326) may be triggered from the TIM server (302) and further process data, and send the processed data to the EMS. Also, the CE (326) may receive the processed data, analyze the processed data, and send the processed data back to the TIM server (302). The EMS may execute the work order changes received from the CE (326) and respond with execution logs. A report engine/report sparks job (318) may create reports at multiple levels for the O&M team. This may include auto-generated reports as well as on-demand reports. These reports may be created at multiple levels i.e. the TIM server (302) and the CE (326). Apart from status reports, analysis reports may also be produced to analyze network data, which may aid in modification of parameters through an administration module.

In an embodiment, a graphic user interface (GUI) (316) may help in a visual representation of the eNodeB/base station across different view ports. Each view port may range from a 50 square meter to a pan-country (for example, India) wide map. Through this visual representation, individual victim cells as well as complete groups of cells may be identified. The cells listed in the visual representation and their associated information may be extracted from different databases including, but not limited to, Oracle, Hadoop distributed file system (HDFS), and MongoDB. For example, Oracle may store cell level information, HDFS may include configuration information, and MongoDB may include geographical data.

As illustrated in FIG. 3, files stored in the TIM server (302) may be provided to an edge node CM tool (304). Further, the edge node CM tool (304) may process and send the files to a HDFS module (306) and further to a spark job zone wise module (308). Further, the spark job zone wise module (308) may receive inputs from a HBase tables module (310), process this information, and send this information to a database manager (312). The HBase tables module (310) and the database manager (312) may receive additional information from an application server (314) configured with a user interface (316) and a remote spark job (318). The database manager (312) may process the information and send the information to a WO master zone wise module (320). Further, the WO master zone wise module (320) may send the processed information to a data pipeline module (324) via a TIM MS instances module (322). The data pipeline module (324) may further send the processed information to the CE (326). The data pipeline module (324) may receive an output from the CE (326) and send the output to a consumer (328). The consumer (328) may update their information in the database manager (312). Further, the database manager (312) may process various information and send schedule tasks via a scheduler's module (330).

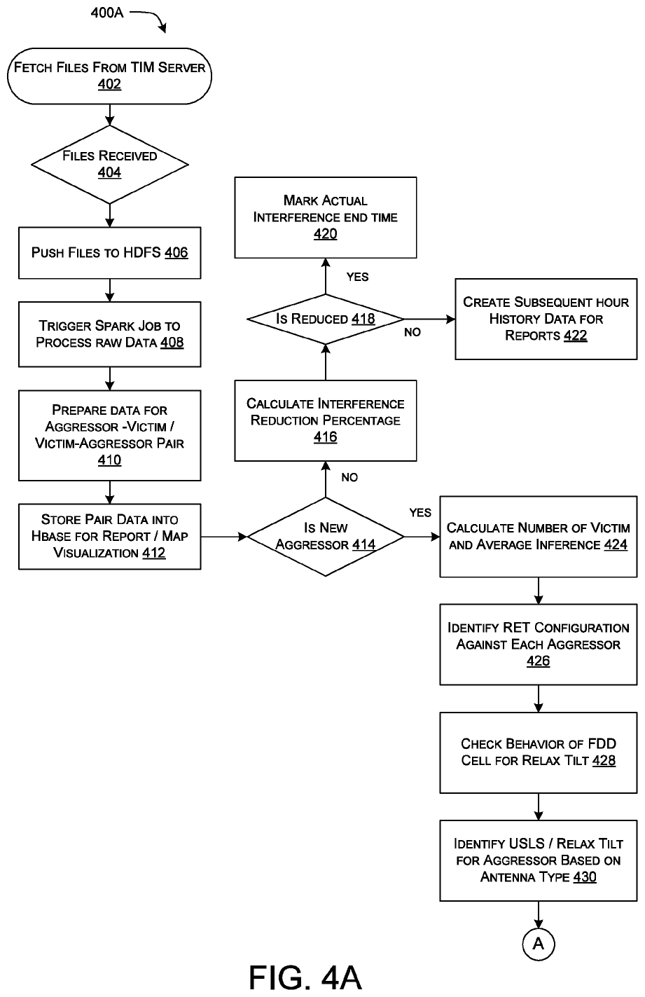

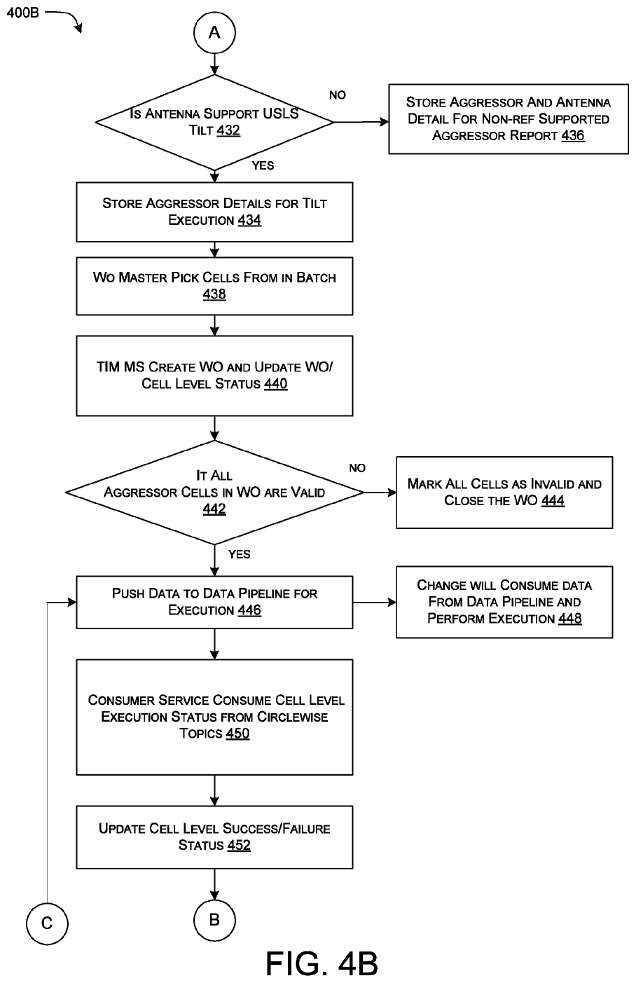

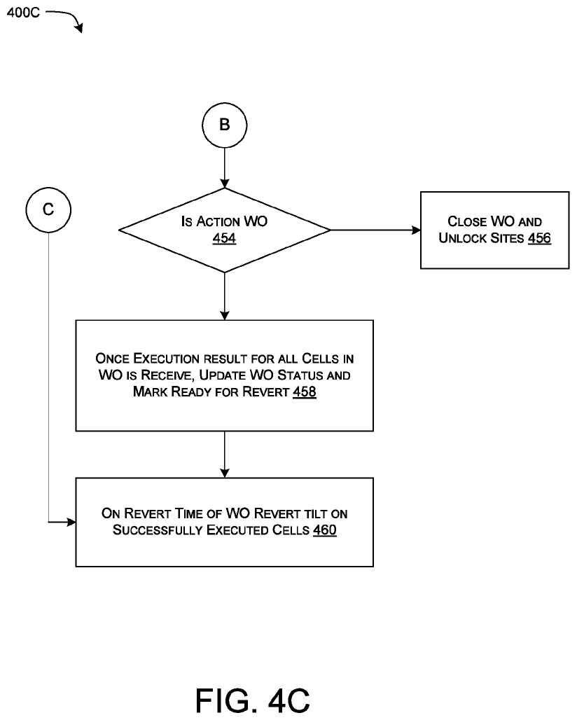

FIGS. 4A-4C illustrates example flow diagrams (400A, 400B, 400C) of TIM processing, in accordance with embodiments of the present disclosure.

As illustrated in FIGS. 4A-4C, in an embodiment, the TIM processing may include the following steps.

At step 402: The system (108) may fetch files from a TIM server.

At step 404: The files may be received by the system (108).

At step 406: The system (108) may push the files to a HDFS.

At step 408: The system (108) may trigger a spark job to process raw data.

At step 410: The system (108) may prepare data for an aggressor-victim, victim-aggressor pair.

At step 412: The system (108) may store pair data into HBase for report/map visualization.

At step 414: The system (108) may determine if a new aggressor may be present.

At step 416: Based on a negative determination from step 414, the system (108) may calculate an interference reduction percentage.

At step 418: The system (108) may determine if the interference has been reduced.

At step 420: Based on a positive determination from step 420, the system (108) may mark an actual interference end time.

At step 422: Based on a negative determination from step 420, the system (108) may create subsequent hour history data for reports.

At step 424: Based on a positive determination from step 414, the system (108) may calculate a number of victim and average interference.

At step 426: The system (108) may identify a remote electrical tilt (RET) configuration against each aggressor.

At step 428: The system (108) may check behaviour of FDD cells for a relax tilt.

At step 430: The system (108) may identify USLS/relax tilt for aggressor based on antenna.

At step 432: The system (108) may determine if the antenna is supporting the USLS tilt.

At step 434: Based on a negative determination from step 434, the system (108) may store the aggressor and the antenna details for non-reference supported aggressor report.

At step 436: Based on a positive determination from step 432, the system (108) may store the aggressor details for tilt execution.

At step 438: The system (108) may generate a work order (WO) master pick cells from the batch.

At step 440: The TIM may create the WO and update the WO/cell level status.

At step 442: The system (108) may determine if a list of all the aggressor cells in the WO is valid.

At step 444: Based on a negative determination from step 444, the system (108) may mark all the cells as invalid and close the WO.

At step 446: Based on a positive determination from step 444, the system (108) push data to the data pipeline for execution.

At step 448: The system (108) may implement data from the data pipeline and perform execution.

At step 450: The system (108) may determine the consumer service consumer cell level execution status from circle wise topics.

At step 452: The system (108) may update the cell level success/failure status. At step 454: The system (108) may determine if the action is a WO.

At step 456: Based on a negative determination from step 454, the system (108) may close the WO and unlock sites.

At step 458: Based on a positive determination from step 454, the system (108) upon receiving an execution result for all the cells in WO, the system (108) may update the WO status and mark ready for revert.

At step 460: The system (108) may on revert time of the WO, revert the tilt on successfully executed cells and continue with step 448.

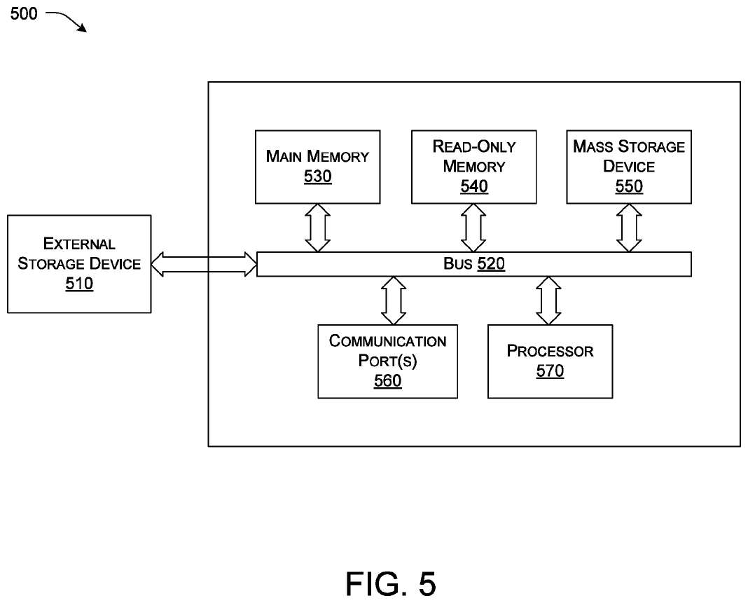

FIG. 5 illustrates an exemplary computer system (500) in which or with which embodiments of the present disclosure may be implemented.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The processor (570) may include various modules associated with embodiments of the present disclosure. The communication port(s) (560) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (560) may be chosen depending on a network, such as a Local Area Network (LAN), Wide Area Network (WAN), or any network to which the computer system (500) connects.

In an embodiment, the main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (520) may communicatively couple the processor(s) (570) with the other memory, storage, and communication blocks. The bus (520) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (570) to the computer system (500).

In another embodiment, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). Components described above are meant only to exemplify various possibilities. In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method where interference associated with the identified victim cells identified are analyzed and corrective measures are implemented.

The present disclosure provides a system and a method that analyses interference data in real-time and identifies aggressor cells in near real-time.

The present disclosure provides a system and a method that decreases the interference on victim cells by more than 60 percent and increases the performance of the network elements and provides a superior user experience.

The present disclosure provides a system and a method where a complete network interference detection and mitigation is achieved with zero human intervention.

We claim:

1. A system (108) for automatic interference detection, the system (108) comprising:
a processor (202); and
a memory (204) operatively coupled with the processor (202), wherein said memory (204) stores instructions which, when executed by the processor (202), cause the processor (202) to:
receive one or more parameters from one or more base stations;
identify one or more interference source cells based on the one or more parameters;
categorize the one or more interference source cells based on one or more regions;
determine a state of frequency division duplex (FDD) cells among the categorized one or more interference source cells;
enable a radio frequency (RF) tilt and an associated power attenuation for time division duplex (TDD) cells associated with the FDD cells of the one or more regions for a predetermined period based on the determined state; and
dynamically update the RF tilt and the associated power attenuation for the TDD cells for the predetermined period.

2. The system (108) as claimed in claim 1, wherein the one or more parameters comprise at least one of: a time duration, an interference level, a geographic distance, a confidence level, and a cell count.

3. The system (108) as claimed in claim 1, wherein the processor (202) is to predict interference associated with the one or more interference source cells based on the one or more parameters.

4. The system (108) as claimed in claim 1, wherein to enable the RF tilt and the associated power attenuation, the processor (202) is to apply an upper side lobe suppression (USLS) and aggressive tilt on the TDD cells based on the state of the FDD cells being one of: a high state, a medium state, and a low state.

5. The system (108) as claimed in claim 4, wherein the processor (202) is to apply a non-USLS and relaxed tilt on the TDD cells based on the state of the FDD cells being a healthy state.

6. The system (108) as claimed in claim 1, wherein the categorization of the one or more interference source cells is based on at least one of: a district, a state, a country, Element Management System (EMS) across the one or more regions, and individual EMS.

7. The system (108) as claimed in claim 1, wherein the processor (202) is to determine a decrease in an interference of the one or more interference source cells in response to enabling of the RF tilt and the associated power attenuation, and revert the RF tilt and the associated power attenuation based on the determination of the decrease in the interference.

8. The system (108) as claimed in claim 1, wherein the processor (202) is to determine the RF tilt based on a main lobe power below a horizon, a main lobe power above the horizon, and a total power associated with one or more upper side lobes from the one or more interference source cells.

9. The system (108) as claimed in claim 1, wherein the processor (202) is to generate a report comprising information corresponding to the one or more interference source cells.

10. A method for automatic interference detection, the method comprising:
receiving, by a processor (202), one or more parameters from one or more base stations;
identifying, by the processor (202), one or more interference source cells based on the one or more parameters;
categorizing, by the processor (202), the one or more interference source cells based on one or more regions;
determining, by the processor (202), a state of frequency division duplex (FDD) cells among the categorized one or more interference source cells;
enabling, by the processor (202), a radio frequency (RF) tilt and an associated power attenuation for time division duplex (TDD) cells associated with the FDD cells of the one or more regions for a predetermined period based on the determined state; and
dynamically updating, by the processor (202), the RF tilt and the associated power attenuation for the TDD cells for the predetermined period.

11. The method as claimed in claim 10, comprising determining, by the processor (202), a decrease in an interference of the one or more interference source cells in response to enabling of the RF tilt and the associated power attenuation, and reverting the RF tilt and the associated power attenuation based on determining the decrease in the interference.

12. The method as claimed in claim 10, wherein enabling, by the processor (202) the RF tilt and the associated power attenuation comprises applying upper side lobe suppression (USLS) and aggressive tilt on the TDD cells based on the state of the FDD cells being one of: a high state, a medium state, and a low state.

13. The method as claimed in claim 11, comprising applying, by the processor (202), a non-USLS and relaxed tilt on the TDD cells based on the state of the FDD cells being a healthy state.

14. A non-transitory computer readable medium comprising a processor with executable instructions, causing the processor to:
receive one or more parameters from one or more base stations;
identify one or more interference source cells based on the one or more parameters;
categorize the one or more interference source cells based on one or more regions;
determine a state of frequency division duplex (FDD) cells among the categorized one or more interference source cells;
enable a radio frequency (RF) tilt and an associated power attenuation with time division duplex (TDD) cells associated with the FDD cells of the one or more regions for a predetermined period based on the determined state; and
dynamically update the RF tilt and the associated power attenuation for the TDD cells for the predetermined period.
